(19) United States
(12) Patent Application Publication
(10) Pub. No.: US 2018/0248954 A1
(43) Pub. Date: Aug. 30, 2018

(54) ESTABLISHING AND CONFIGURING IOT DEVICES

(71) Applicant: Xenio Corporation, San Francisco, CA (US)

(72) Inventors: Reza S. RAJI, Menlo Park, CA (US); Howard HERRERA, Carlsbad, CA (US)

(21) Appl. No.: 15/654,340

(22) Filed: Jul. 19, 2017

Related U.S. Application Data
(60) Provisional application No. 62/364,264, filed on Jul. 19, 2016.
(60) Provisional application No. 62/446,643, filed on Jan. 16, 2017.
(60) Provisional application No. 62/446,671, filed on Jan. 16, 2017.
(60) Provisional application No. 62/446,690, filed on Jan. 16, 2017.
(60) Provisional application No. 62/471,634, filed on Mar. 15, 2017.
(60) Provisional application No. 62/472,200, filed on Mar. 16, 2017.
(60) Provisional application No. 62/471,645, filed on Mar. 15, 2017.
(60) Provisional application No. 62/472,207, filed on Mar. 16, 2017.
(60) Provisional application No. 62/471,660, filed on Mar. 15, 2017.
(60) Provisional application No. 62/472,216, filed on Mar. 16, 2017.
(60) Provisional application No. 62/503,414, filed on May 9, 2017.

(51) Int. Cl. H04L 29/08; H04W 4/38; H04B 17/318; H04W 64/00; H04L 12/24

(52) U.S. Cl. CPC H04L 67/12; H04W 4/38; H04L 41/0806; H04W 64/006; H04B 17/318

(57) ABSTRACT

Embodiments establish or configure deployed IOT devices to connect and communicate with a cloud-based platform or computer network. A mobile device for establishing deployed devices includes a receiver that receives an incoming signal from at least one of the deployed devices, a processor that analyzes the incoming signals received from the deployed devices to determine which of the deployed devices is adjacent to the mobile device, and a transmitter that sends an outgoing signal to the adjacent deployed devices. A method for establishing deployed devices includes receiving an incoming signal from at least one of the deployed devices, determining which of the deployed devices is adjacent to the mobile device by analyzing the incoming signal strengths received from all the deployed devices, and transmitting an outgoing signal to the adjacent the deployed devices.

### RELATED APPLICATIONS

This application claims the benefit of U.S. Patent Application No. 62/364,264, filed Jul. 19, 2016.

This application claims the benefit of U.S. Patent Application No. 62/446,643, filed Jan. 16, 2017.

This application claims the benefit of U.S. Patent Application No. 62/446,671, filed Jan. 16, 2017.

This application claims the benefit of U.S. Patent Application No. 62/446,690, filed Jan. 16, 2017.

This application claims the benefit of U.S. Patent Application No. 62/471,634, filed Mar. 15, 2017.

This application claims the benefit of U.S. Patent Application No. 62/472,200, filed Mar. 16, 2017.

This application claims the benefit of U.S. Patent Application No. 62/471,645, filed Mar. 15, 2017.

This application claims the benefit of U.S. Patent Application No. 62/472,207, filed Mar. 16, 2017.

This application claims the benefit of U.S. Patent Application No. 62/471,660, filed Mar. 15, 2017.

This application claims the benefit of U.S. Patent Application No. 62/472,216, filed March 16, 2017.

This application claims the benefit of U.S. Patent Application No. 62/503,414, filed May 9, 2017.

### FIELD OF THE INVENTION

The present invention generally relates to establishing Internet-of-Things (IOT) devices and more particularly to establishing smart lighting systems incorporating IOT technology and deployed in the field.

### BACKGROUND

IOT devices are being developed to work in many different applications including lighting, security, automation, and control. Most buildings have lighting fixtures arranged according to a predetermined pattern optimized to deliver uniform lighting throughout a space. One problem with installing IOT technology is establishing the IOT device within the premises to be part of a network. Establishing an IOT device includes both the initial installation/setting up of the IOT device and/or the on-going maintenance of the already installed IOT device. For example, when an IOT device is initially installed, the IOT device is also established by setting it up and commissioning it so that the IOT device has an address to communicate with a network of computers such as the internet. Similarly, after an IOT device has been installed and established for the first time, the IOT device will likely be established again as part of its maintenance. An example of establishing an IOT device that is already installed, setup and running is providing a new address for the IOT , changing the address of the IOT device, re-loading the same address or instructions of the IOT device after the software has been upgraded or reloaded, subsequently setting up groups of IOT devices and scenes of the IOT devices. Establishing an IOT device can be difficult because a user has to physically identify the device and individually establish the IOT device.

Therefore what is needed is a system and method for efficiently establishing deployed IOT devices with an address that allows the IOT device to connect and communicate with a network.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 shows a mobile device establishing a deployed device that is adjacent to the mobile device, under an embodiment.

FIG. 2 is a block diagram of a first device 110 used to establish the deployed devices 120, under an embodiment.

FIG. 3A is a block diagram of a deployed device 120, which is being established by the first device 110, under an embodiment.

FIG. 3B is an isometric view of a lighting assembly, which is an example of a deployed device 120, under an embodiment.

FIG. 3C is an example circuit diagram incorporated into a printed circuit board assembly (PCBA) used in the lighting assembly (FIG. 3B), under an embodiment.

FIG. 4 is a flow chart for a method used by a first device to establish deployed devices with an address that allows the deployed device to connect and communicate with a network, under an embodiment.

FIG. 5 is a flow chart for a method used by a deployed device to receive an address and become established to connect and communicate with a network, under an embodiment.

### DETAILED DESCRIPTION

Embodiments are directed to techniques and systems used to efficiently establish deployed Internet-of-Things (IOT) devices configured with an address that configures the IOT device to connect and communicate with a network. The IOT devices include, for example, one or more of a sensor, detector, beacon, controller, security device, audio component, video component, other network device, lighting component, and a component of a host device or system, but are not so limited.

Embodiments enable an easy to use, fast, and cost-effective apparatus and method for establishing or configuring deployed IOT devices with an address that allows the IOT device to connect and communicate with a computer network or the cloud (e.g., cloud-based computing platform or system). Establishment of an IOT device comprises one or more of the initial installation, configuration, setting up, and maintenance of the IOT device. For example, when an IOT device is initially installed as described herein, the IOT device is also established by setting it up, configuring it, and commissioning it so that the IOT device has an address to communicate with a network of computers (e.g., via the internet). Similarly, after an IOT device has been installed and established for the first time, the IOT device will likely be established again as part of its maintenance, upgrading and/or repairing. An example of establishing an IOT device that is already installed, setup and running is providing a new address for the IOT device, changing the address of the IOT device, re-loading the same address or instructions of the IOT device after the software has been upgraded or reloaded, and subsequently setting up groups of IOT devices and/or scenes of the IOT devices, to name a few.

Embodiments include a mobile device or portable computing device configured to establish or configure deployed devices including IOT devices. The mobile device includes a receiver configured to receive an incoming signal from at least one of the deployed devices, a processor configured to analyze incoming signals received from the deployed devices to determine which of the deployed devices is adjacent or nearest to the mobile device, and a transmitter configured to send an outgoing signal to the adjacent or nearest of the deployed devices. In some embodiments, the deployed devices include one or more of light sources, lighting assemblies, sensors, detectors, controllers, security devices, other network devices, and one or more components of a host device or system.

The mobile device of an embodiment is configured to analyze the incoming signals to determine which of the deployed devices is adjacent or nearest to the mobile device by comparing the incoming signal strengths received from the deployed devices and determining the distance from the mobile device to the deployed devices according to incoming signal strength. The incoming signals each include a unique device identifier corresponding to the deployed device that transmitted the signal, but are not so limited. In an embodiment the mobile device analyzes the incoming signals to determine which of the deployed devices is adjacent or nearest to the mobile device by comparing the incoming signal strengths received from the deployed devices and determining the distance from the mobile device to the deployed devices using the incoming signal strength.

The mobile device, which in an embodiment includes a portable computing device such as a smart phone and/or tablet computer, is configured to transmit the outgoing signal comprising a radio frequency (RF) or radio signal. The outgoing signal is configured to provide information to establish the deployed devices. More particularly, the information in the outgoing signal is configured to establish the deployed device that is adjacent or nearest to the mobile device at approximately the time of signal transmission. The outgoing signal from the transmitter can provide an address comprising one or more of a logical address, a tag, a network address, a location string, and other means of addressing, for example. The mobile device of an embodiment includes a configuration application configured to analyze the incoming signals and/or generate the outgoing signal, but is not so limited.

The mobile device of an embodiment is configured to transmit a second outgoing signal to at least one other computer, for example a network computer located on the cloud, at the premises, and/or remote to the premises. The second outgoing signal is configured to communicate to the network computer information about the deployed device, which is being established, such as the unique identifier and the address provided to the deployed device. The mobile device of an embodiment includes a configuration application configured to generate the second outgoing signal, but is not so limited.

The deployed device of an embodiment includes a transmitter configured to send an outgoing signal comprising a unique identifier of the deployed device, however the outgoing signal can include additional or alternative data or information. The deployed device also includes a receiver configured to receive an incoming signal comprising an address, however the incoming signal can include additional or alternative data or information. A processor of the deployed device is configured to associate the received address with the deployed device having the unique identifier. The deployed device includes an IOT device, for example, one or more of a sensor, detector, beacon, controller, security device, audio component, video component, other network device, lighting component, and a component of a host device or system, but are not so limited. The deployed device also includes one of a group of devices deployed in an area such as an office, commercial, retain, or residential space. The deployed devices of the group can be deployed according to a pattern, but are not so limited.

Embodiments include a method executed or performed by the mobile device to establish or configure the deployed devices. The method includes receiving an incoming signal from at least one of the deployed devices, determining which of the deployed devices is adjacent or nearest to the mobile device by analyzing the incoming signals received from all the deployed devices, and transmitting an outgoing signal to the adjacent or nearest of the deployed devices. The incoming signals are analyzed to determine which of the deployed devices is adjacent or nearest to the mobile device by comparing the incoming signal strengths received from the deployed devices and determining the distance from the mobile device to the deployed devices according to incoming signal strength. The incoming signal is also configured to include a unique device identifier of each of the deployed devices, but is not so limited. The outgoing signal is configured to include information to establish the adjacent or nearest of the deployed devices. Transmission of the outgoing signal comprises transmitting an address such as one or more of a logical address, a tag, a network address, a location string, and other means of addressing but is not limited to only these types of data or information.

The method of an embodiment includes transmitting a second outgoing signal to another computer, which can be a network computer located on the cloud, or located on or remote to the premises. The second outgoing signal can be used by the mobile device to communicate to the network computer information about the deployed device, which is being established, such as the unique identifier and the address provided to the deployed device.

According to another embodiment, a method for establishing or configuring a deployed IOT device includes transmitting an outgoing signal comprising a unique identifier of the device and, in response, receiving an incoming signal comprising an address, processing the incoming signal to determine the address, and assigning the address to the IOT device that transmitted the unique identifier. The outgoing signal can include data or information in addition to or alternative to the unique identifier of the device. Similarly, the incoming signal can include information in addition to or alternative to the address to be assigned to the device. The incoming and outgoing signals include radio frequency or radio signals, but are not so limited. The determining of the address includes but is not limited to determining one or more of a logical address, a network address, a location string, and a tag.

Methods of an embodiment include methods for establishing or configuring deployed first device(s) that has previously been established or configured to include a first address assigned to it for communicating with a network computer. The methods for re-establishing include looking up the first address based on information previously provided by a second device when the first device was previously established, and sending a first network signal from a computer network to the first address. The sending of the first network signal from the computer network includes sending information and/or instructions to the first device.

Methods of an embodiment include methods for establishing or configuring multiple deployed devices, each of which includes an individual address assigned to it for communicating with a network computer. These methods for establishing multiple deployed devices include sending network signals from a computer network to one or more of the deployed devices. Additionally, the method can include receiving an outgoing signal from at least one of the deployed devices. In some embodiments, the deployed devices include IOT devices previously established, and the network signals comprise information for each of the deployed devices to form a group. Additionally, the method may include sending additional network signals to at least one of the deployed devices and/or receiving an outgoing signal from at least one of the deployed devices.

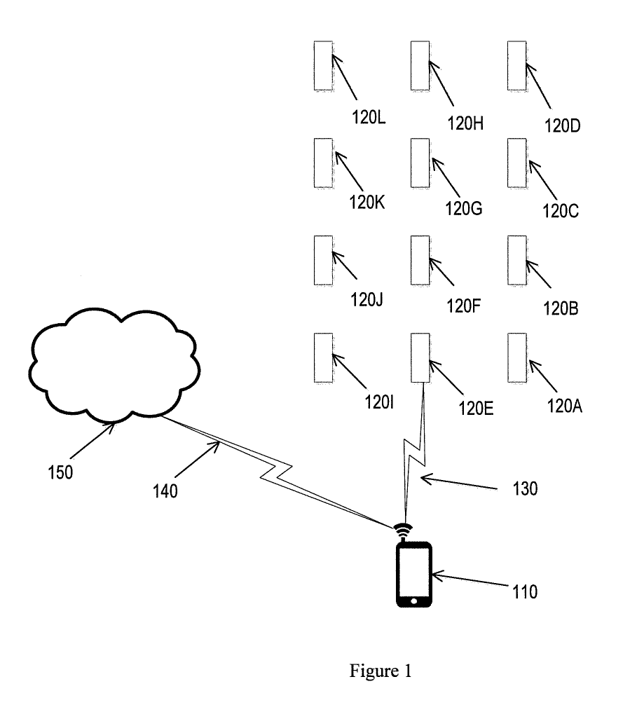

FIG. 1 shows a mobile device 110 establishing a group of deployed devices 120A, . . . , 120L positioned in regular rectangular pattern and communicating with a computer network 150, under an embodiment. Mobile device 110 is portable and includes one or more of a smart phone and other handheld device configured for carriage by a user. Deployed devices 120A, . . . , 120L that are being established can be any group of devices that need to be established with an address and/or data or information. For example, deployed devices 120A, . . . , 120L include IOT devices, for example, one or more of a lighting assembly, sensor, detector, controller, security device, speaker, other network device, and a component of a host device or system, but are not so limited. In an embodiment, deployed devices 120A, . . . , 120L include light assemblies with light sources configured to be smart lighting modules that communicate and couple or connect with other devices. Computer network 150, which includes a cloud-based platform or cloud, comprises one or more computers, with memory, configured to communicate with other computer(s) and/or external device(s). Mobile device 110 communicates with deployed devices 120A, . . . , 120L by exchanging data or information via one or more of wireless signals 130 and wired signals. Wireless signals 130 include RF signals, Bluetooth signals, visible light signals, non-visible light signals, and/or sound waves, but are not so limited.

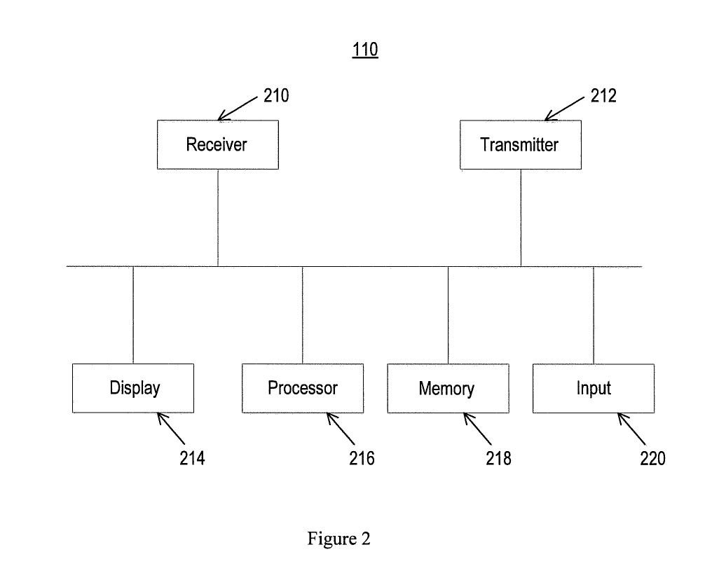

FIG. 2 is a block diagram of a mobile device 110 configured to establish deployed devices 120A, . . . , 120L, under an embodiment. Mobile device 110 is configured to include a receiver 210, a transmitter 212, a display 214, a processor 216, a memory 218, and an input 220, but is not so limited. Receiver 210 and transmitter 212 are used to receive and transmit signals, respectively are coupled or connected to the same or different antennas. Display 214 includes a touch screen or other display as used with mobile smart phone devices. Processor 216 and memory 218 are configured to process received and transmitted information. Input 220 includes a component incorporated into display 214 and/or a standalone input device such as a keypad or keyboard.

Receiver 210 of mobile device 110 is configured to receive an incoming signal 130 from at least one of the deployed devices 120A, . . . , 120L. Processor 216 is configured to analyze the incoming signals received from the deployed devices 120A, . . . , 120L to determine which of the deployed devices is adjacent or nearest to mobile device 110. Transmitter 212 is configured to send an outgoing signal to the adjacent or nearest 120E of the deployed devices. The outgoing signal transmitted by mobile device 110 is configured to provide information to establish one or more of the deployed devices 120A, . . . , 120L. The information in the outgoing signal is configured to establish the deployed device that is adjacent or nearest to mobile device 110 at the time of signal transmission. Mobile device 110 is configured to use processor 216 and memory 218 to analyze the incoming signals to determine which of the deployed devices 120A, . . . , 120L is adjacent or nearest to mobile device 110. This determination comprises performing a comparison of the signal strengths of the signals received from the deployed devices 120A, . . . , 120L, and associating or determining the distance from mobile device 110 to the deployed devices 120A, . . . , 120L according to the signal strength data or information. The incoming signal is configured to include a unique device identifier of each of the deployed devices 120A, . . . , 120L, but is not so limited. The outgoing signal transmitted by the transmitter 212 is configured to include an address such as one or more of a logical address, a tag, a network address, a location string, and other means of addressing, but is not so limited.

Mobile device 110 can be configured to transmit a second outgoing signal 140 to another computer, which can be a network computer 150 located on the cloud, at the premises, and/or remote to the premises. The second outgoing signal 140 is configured for use by mobile device 110 to communicate to the network computer 150 information about the deployed device 120A, . . . , 120L, which is being established, such as the unique identifier and the address provided to the deployed device.

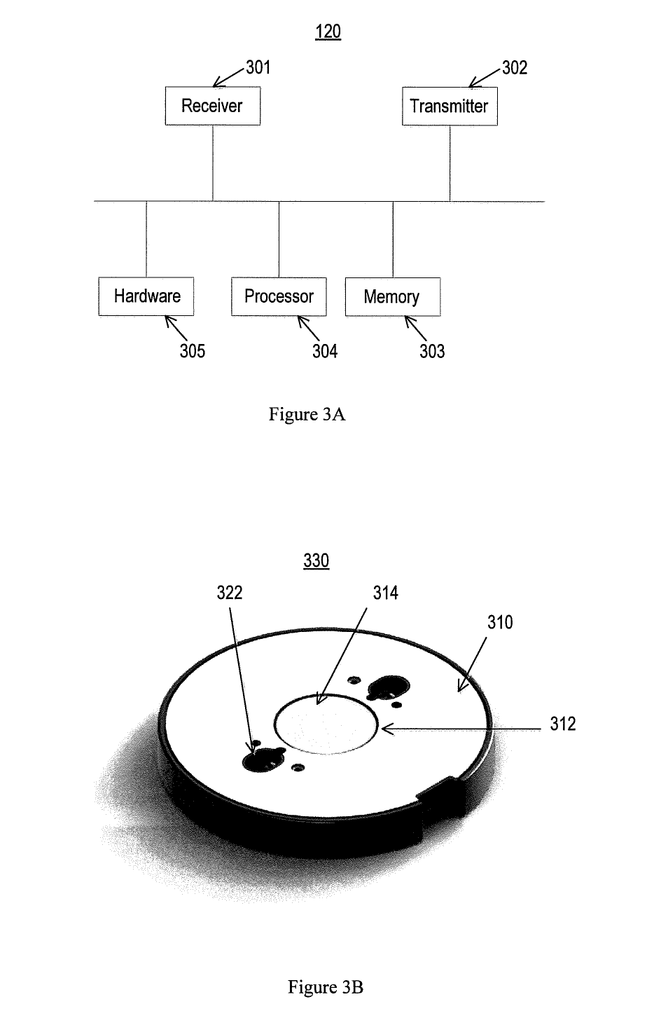

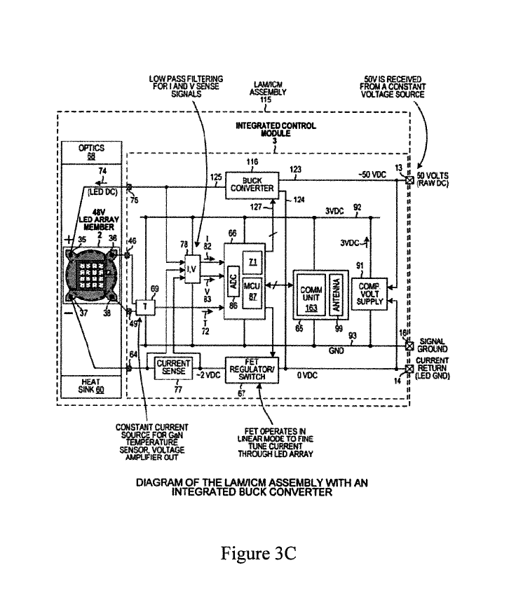

FIG. 3A is a block diagram of a deployed device 120, under an embodiment. Deployed device 120 (which generically represents any one of the deployed devices 120A, . . . , 120L) is configured to include a receiver 301, a transmitter 302, a memory 303, a processor 304, and other hardware 305 as appropriate to device type and/or configuration. Receiver 301 and transmitter 302 are configured to receive and transmit signals, respectively and are coupled or connected to the same or different antennas. Memory 303 and processor 304 are configured to process information and transmit the information using the transmitter 302. Hardware 305 includes, for example, the different devices that can be incorporated, included or components of the deployed devices 120A, . . . , 120L. For example if the deployed devices 120A, . . . , 120L are lighting assemblies, then hardware 305 includes the light source and electronics for using the light source. Hardware 305 comprises numerous types of hardware, for example, a light source, environment sensors, occupancy sensors, smoke sensors, and temperature sensors, to name a few.

Transmitter 302 is configured to send an outgoing signal comprising a unique identifier of the deployed device 120. Receiver 301 is configured to receive an incoming signal comprising an address. Memory 303 and processor 304 are configured to associate the address received with the deployed device 120 corresponding to the unique identifier. The outgoing signal can include additional or alternative data to the unique identifier of the deployed device 120. Similarly, the incoming signal can include additional or alternative data to the address to be assigned to the deployed device 120 with the unique identifier. Deployed device 120 can also be one of a group of deployed devices 120A, . . . , 120L that are deployed in an area such as an office, commercial, retail, or residential premise or space. The deployed devices 120A, . . . , 120L can be deployed and arranged according to a pattern but are not so limited.

FIG. 3B is an isometric view of a lighting assembly 330, which is an example of a deployed device 120, under an embodiment. Lighting assembly 330 includes a components cap 310, a printed circuit board assembly (PCBA) 312, a light engine 314, and mounting holes 322. The mounting holes 322 are positioned on top of the lighting assembly.

FIG. 3C is an example circuit diagram of electronic components of the lighting assembly 330 incorporated into a PCBA 312, under an embodiment. PCBA 312 is illustrated with the heat spreader 60 and with optics 68 denoted as blocks. The microcontroller 66 is configured to monitor the temperature of the LED array member (LAM) 2 via a temperature interface circuit 69. Temperature interface circuit 69 includes a constant current source configured to supply a constant current 70 to the temperature sensing GaN die 32 via ISM contact pad 46, LAM contact pad 36, LAM contact pad 38 and ISM contact pad 49. The temperature interface circuit 69 also includes a voltage amplifier configured to amplify the sensed voltage across LAM contact pads 36 and 38 and supply the resulting amplified voltage signal T 72 to the microcontroller 66 via conductor 73.

Additionally, microcontroller 66 is configured to monitor the voltage V with which the LEDs of LAM 2 are driven. This LED drive voltage is the voltage between LAM contact pads 35 and 37. A current and voltage measuring interface circuit 78 is configured to measure this voltage via conductors 79 and 80. In addition, microcontroller 66 is configured to monitor the LED drive current 74 flowing through the LEDs of the LAM 2. This current 74 flows from pin 13, through ISM contact pad 75, through LAM contact pad 35, through the LEDs, through LAM contact pad 37, through ISM contact pad 64, through current sense resistor 77, through FET switch 67, out of the LAM/ISM assembly via pin 14.

The current and voltage measuring interface circuit 78 is configured to detect the LED drive current 74 as the voltage dropped across the current sense resistor 77. This voltage is detected across conductors 80 and 81. The voltage and current measuring interface circuit 78 is configured to receive the voltage sense and current sense signals, apply the signals to a low pass filter, amplify the filtered signals, and perform level shifting and scaling to generate a voltage sense signal V 82 and a current sense signal I 83. The voltage and current sense signals 82 and 83 are supplied to the microcontroller 66 via conductors 84 and 85, respectively.

The T signal 72, V signal 82, and I signal 83 are converted into digital values by the analog-to-digital converter (ADC) 86 of the microcontroller. A main control unit (MCU) 87 of the microcontroller is configured to execute a program 71 of processor-executable instructions. The I, V and T signals, as well as information received from communication integrated circuit 65, are used by the MCU 87 to determine how to control FET switch 67. In the present example, the MCU 87 is configured to control the FET switch to be nonconductive, thereby turning off the LEDs. The MCU 87 is configured to control the FET switch to be fully conductive, thereby turning on the LEDs to a brightness proportional to the current supplied by the AC-DC converter as controlled by the zero to ten volt signal also produced by the MCU as directed by the control program.

The ISM 3 is configured to receive a substantially constant current via pins 13 and 14 from an AC-to-DC power supply circuit 88. The AC-to-DC power supply circuit 88 has a constant current output, the magnitude of the constant current being controllable by a zero to ten volt signal received by the AC-to-DC power supply circuit. The voltage that results across pins 13 and 14 when this constant current is being supplied to the LAM/ISM assembly 1 is approximately 50 volts. The microcontroller 66 is configured to control the FET switch 67 to be fully on with nearly zero voltage across it when the LAM is to be illuminated. To accomplish control for a desired LED brightness (desired amount of current flow through the LEDs of the LAM), the microcontroller 66 is configured to send a dimming control signal 89 (zero to ten volt) back to the AC-to-DC power supply circuit 88 via conductor 90, and data terminal 15. The microcontroller 66 is configured to use this control signal 89 to increase and to decrease the magnitude of the constant current 74 being output by the AC-to-DC power supply circuit 88.

The circuit components 69, 78, 66 and 65 are powered from a low DC supply voltage such as 3 volts DC. A component voltage supply circuit 91 is configured to generate this 3 volt supply voltage from the 50 volts across pins 13 and 14. The 3 volt supply voltage is supplied onto voltage supply conductor 90. Conductor 93 is the ground reference conductor for the component supply voltage. Because only a small amount of power is required to power the circuitry embedded in the ISM, the component voltage supply circuit 91 may be a simple linear voltage regulator.

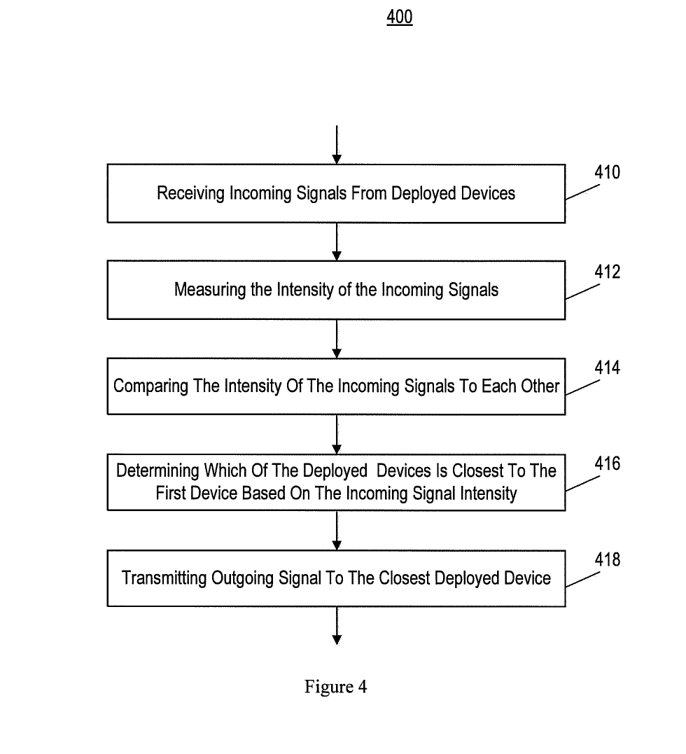

FIG. 4 is a flow chart 400 for a method used by a first device 110 to establish deployed devices 120A, . . . , 120L, under an embodiment. The deployed devices 120A, . . . , 120L are established or configured with an address that configures deployed device 120A, . . . , 120L to couple or connect and communicate with a computer network 150. In operation 410, mobile device 110 is configured to receive an incoming signal from at least one of the deployed devices 120A, . . . , 120L. The incoming signal is configured to include a unique device identifier of each of the deployed devices 120A, . . . , 120L. In operation 412, mobile device 110 is configured to measure the intensity of the incoming signal. In operation 414, mobile device 110 is configured to compare to each other the measured intensities of all the incoming signals from the various deployed devices 120A, . . . , 120L. In operation 416, mobile device 110 is configured to determine based on the incoming signal strength the deployed device adjacent or nearest to the mobile device 110. This determination comprises associating the distance of the deployed devices 120A, . . . , 120L from the mobile device with the incoming signal strength so that the strongest incoming signal strength is associated as being nearer (shorter distance) and the weakest incoming signal strength is associated as being further away (longer distance). In operation 418, the mobile device 110 is configured to transmit an outgoing signal to the adjacent or nearest deployed device. The outgoing signal can include data or information to establish the nearest of the deployed devices but is not so limited. For example, the outgoing signal can include one or more of an address, a logical address, a tag, a network address, a location string, and other means of addressing.

The method of an embodiment includes transmitting a second outgoing signal from the mobile device 110 to another computer, which can be a network or cloud-based computer 150 at or remote to the premises. The second outgoing signal is configured by the mobile device to communicate to the network computer 150 information about the deployed device 120A, . . . , 120L, which is being established, such as the unique identifier and the address provided to the deployed device, for example.

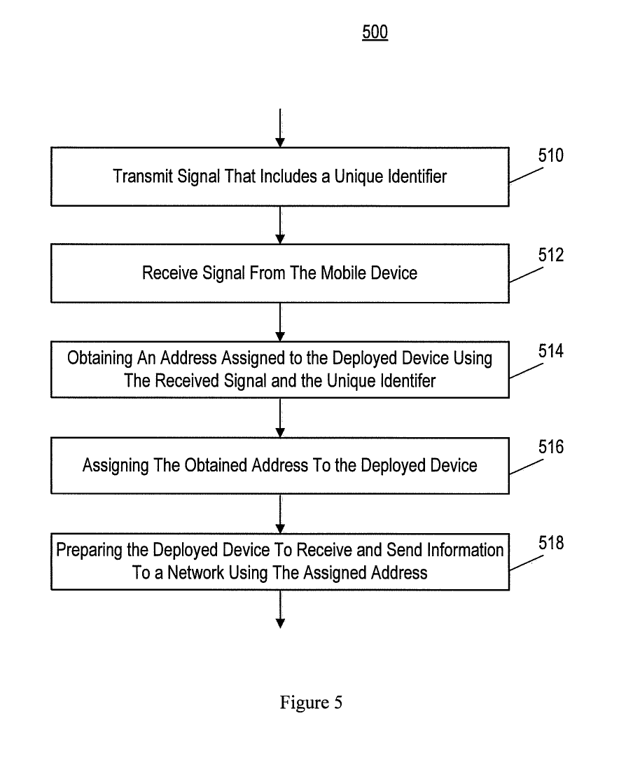

FIG. 5 is a flow chart 500 for a method used by one or more of the deployed devices 120A, . . . , 120L, under an embodiment. The deployed devices 120A, . . . , 120L are established or configured to receive an address and become configured to couple or connect and communicate with a network. In operation 510, a deployed device 120 is configured to transmit an outgoing signal comprising a unique device identifier, but is not so limited as the outgoing signal can include additional or alternative data or information. In operation 512, and in response to the transmitted device identifier, deployed device 120 is configured to receive an incoming signal from mobile device 110 that includes an address, but is not so limited as the incoming can include additional or alternative data or information. In operation 514, deployed device 120 is configured to process the incoming signal to determine and obtain the address or other data. The address assigned to the deployed device is obtained using the received signal and the unique identifier. The obtained address includes one or more of a logical address, a network address, a location string, and a tag, but is not so limited. In operation 516, the obtained addressed is assigned to the deployed device 120. In operation 518, deployed device 120 is configured to receive and send information to a computer network using the assigned address.

Embodiments include a first device configured to establish a plurality of second devices. The first device comprises a receiver configured to receive incoming signals from the plurality of second devices. The first device includes a processor configured to analyze the incoming signals received from the plurality of second devices to determine which of the plurality of second devices is adjacent to the first device. The first device includes a transmitter configured to send an outgoing signal to the adjacent second device.

Embodiments include a first device configured to establish a plurality of second devices, the first device comprising: a receiver configured to receive incoming signals from the plurality of second devices; a processor configured to analyze the incoming signals received from the plurality of second devices to determine which of the plurality of second devices is adjacent to the first device; a transmitter configured to send an outgoing signal to the adjacent second device.

The plurality of second devices includes at least one of a sensor and a detector

The plurality of second devices includes at least one of a beacon, controller, security device, audio component, video component, lighting component, network device, Internet-of-Things device, and component of a system.

The establishing comprises first communications via a first channel between the first device and the plurality of second devices, and second communications via a second channel between the first device and a cloud computer.

The first device is configured to be portable.

The first device includes at least one of a smart phone, tablet computer, and portable computing device.

The processor is configured to run a configuration application to analyze the incoming signals, and generate the outgoing signal.

The outgoing signal is configured to include information to establish the adjacent second device of the plurality of second devices.

The outgoing signal is configured to include information to establish as the adjacent second device a nearest one of the plurality of second devices.

The outgoing signal is configured to include a radio frequency signal.

The analyzing the incoming signals comprises comparing signal strengths of the incoming signals received from the plurality of second devices, and determining the distance of the first device to the plurality of second devices using the signal strength.

The incoming signal is configured to include a unique device identifier of a corresponding device of the at least one of the second devices.

The outgoing signal from the transmitter is configured to include an address.

The transmitter is configured to transmit a second outgoing signal to another device.

The second outgoing signal is configured to include the unique identifier and the address.

Subsequent to detecting a change in location of the first device relative to the plurality of second devices, the receiver is configured to receive the incoming signals from the plurality of second devices, the processor is configured to analyze the incoming signals received from the plurality of second devices to determine another second device adjacent to the first device, the transmitter is configured to send the outgoing signal to the other second device, wherein the outgoing signal comprises information to configure the other second device.

Embodiments include a method for establishing a plurality of second devices comprising. The method comprises receiving at a first device incoming signals from the plurality of the second devices. The method comprises determining which of the plurality of second devices is adjacent to the first device by analyzing the incoming signals. The method comprises transmitting an outgoing signal to the adjacent second device, wherein the outgoing signal includes data to configure the adjacent second device.

Embodiments include a method for establishing a plurality of second devices comprising: receiving at a first device incoming signals from the plurality of the second devices; determining which of the plurality of second devices is adjacent to the first device by analyzing the incoming signals; and transmitting an outgoing signal to the adjacent second device, wherein the outgoing signal includes data to configure the adjacent second device.

The plurality of second devices includes at least one of a sensor and a detector.

The plurality of second devices includes at least one of a beacon, controller, security device, audio component, video component, lighting component, network device, Internet-of-Things device, and component of a system.

The configuring comprises first communications via a first channel between the first device and the plurality of second devices, and second communications via a second channel between the first device and a cloud computer.

The first device is configured to be portable.

The first device includes at least one of a smart phone, tablet computer, and portable computing device.

The transmitting the outgoing signal comprises transmitting information to establish the adjacent second device.

The transmitting the outgoing signal comprises transmitting information to establish as the adjacent second device a nearest one of the plurality of second devices.

The outgoing signal is a radio signal.

The analyzing the incoming signals comprises, comparing signal strengths of the incoming signals received from the plurality of second devices, and determining the distance of the first device to the plurality of second devices using the signal strength.

The method comprises configuring the incoming signal to include a unique device identifier of a corresponding device of the plurality of second devices.

The method comprises configuring the outgoing signal from the transmitter to include an address.

The method comprises configuring the transmitter to transmit a second signal to another device.

The method comprises configuring the second signal to include the unique identifier and the address.

The method comprises detecting a change in location of the first device relative to the plurality of second devices, receiving at the first device incoming signals from the plurality of the second devices, determining another second device adjacent to the first device by analyzing the incoming signals, and transmitting an outgoing signal to the other second device, wherein the outgoing signal includes data to configure the other second device.

Embodiments include a device, comprising a transmitter configured to send an outgoing signal. The outgoing signal comprises a unique identifier of the device. The device includes a receiver configured to receive an incoming signal. The incoming signal comprises an address. The device includes a processor configured to associate the address received with the unique identifier.

Embodiments include a device, comprising: a transmitter configured to send an outgoing signal, wherein the outgoing signal comprises a unique identifier of the device; a receiver configured to receive an incoming signal, wherein the incoming signal comprises an address; and a processor configured to associate the address received with the unique identifier.

The incoming signal is transmitted by a remote device in response to receipt of the outgoing signal.

The device is configured as at least one of a sensor and a detector.

The device is configured as at least one of a beacon, controller, security device, audio component, video component, lighting component, network device, Internet-of-Things device, and component of a system.

The device is one of a plurality of devices deployed in an area.

The device and the plurality of devices are deployed according to a pattern.

The incoming signal is addressed to the device when the device is adjacent to a remote device transmitting the incoming signal.

The incoming signal is addressed to the device when the device is nearer to a remote device transmitting the incoming signal than the plurality of devices.

Embodiments include a method for establishing a device, comprising transmitting an outgoing signal. The outgoing signal comprises a unique identifier of the device. The method comprises receiving an incoming signal. The incoming signal comprises an address. The method comprises processing the incoming signal to determine the address. The method comprises assigning the address to the device that transmitted the outgoing signal with the unique identifier.

Embodiments include a method for establishing a device, comprising: transmitting an outgoing signal, wherein the outgoing signal comprises a unique identifier of the device; receiving an incoming signal, wherein the incoming signal comprises an address; and processing the incoming signal to determine the address; and assigning the address to the device that transmitted the outgoing signal with the unique identifier.

The method comprises transmitting the incoming signal from a remote device in response to receipt of the outgoing signal.

The method comprises addressing the incoming signal to the device when the device is at least one of adjacent and nearest to a remote device transmitting the incoming signal.

The determining the address comprises determining a logical address.

The determining the address comprises determining a network address.

The determining the address comprises determining a location string.

The determining the address comprises determining a tag.

The inventions and methods described herein can be viewed as a whole, or as a number of separate inventions that can be used independently or mixed and matched as desired. All inventions, steps, processes, devices, and methods described herein can be mixed and matched as desired. All previously described features, functions, or inventions described herein or by reference may be mixed and matched as desired.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

Various aspects of the embodiments described herein are with reference to drawings that are schematic illustrations of idealized configurations of the embodiments. As such, variations from the shapes of the illustrations resulting from manufacturing techniques, tolerances, etc., are to be expected. Thus, the various aspects of the embodiments herein should not be construed as limited to the particular shapes of elements (e.g., transmission modules, processor modules, receiving modules, memory modules, etc.) illustrated and described herein, but are to include deviations in shapes that result, for example, from manufacturing. By way of example, an element illustrated or described as a rectangle may have rounded or curved features and/or a gradient concentration at its edges rather than a discrete change from one element to another.

Furthermore, relative terms, such as “lower” or “bottom” and “upper” or “top,” may be used herein to describe one element's relationship to another element as illustrated in the drawings. It will be understood that relative terms are intended to encompass different orientations of an apparatus in addition to the orientation depicted in the drawings. By way of example, if an apparatus in the drawings is turned over, elements disclosed as being on the “lower” side of other elements would then be oriented on the “upper” side of the other elements. The term “lower” can therefore encompass both an orientation of “lower” and “upper,” depending on the particular orientation of the apparatus. Similarly, if an apparatus in the drawing is turned over, elements described as “below” or “beneath” other elements would then be oriented “above” the other elements. The terms “below” or “beneath” can therefore encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Various disclosed aspects may be illustrated with reference to one or more exemplary configurations. As used herein, the term “exemplary” means “serving as an example, instance, or illustration,” and should not necessarily be construed as preferred or advantageous over other configurations disclosed herein.

Furthermore, various descriptive terms used herein, such as “transmitter” and “receiver,” should be given the broadest meaning possible within the context of the present disclosure. It will be understood that when an element such as a region, layer, section, substrate, or the like, is referred to as being “coupled” another element, it can be directly connected to the other element or intervening elements may also be present. In contrast, when an element is referred to as being “directly connected” another element, there are no intervening elements present.

What is claimed is:

1. A first device configured to establish a plurality of second devices, the first device comprising:
a receiver configured to receive incoming signals from the plurality of second devices;
a processor configured to analyze the incoming signals received from the plurality of second devices to determine which of the plurality of second devices is adjacent to the first device;
a transmitter configured to send an outgoing signal to the adjacent second device.

2. The first device of claim 1, wherein the plurality of second devices includes at least one of a sensor and a detector.

3. The first device of claim 1, wherein the plurality of second devices includes at least one of a beacon, controller, security device, audio component, video component, lighting component, network device, Internet-of-Things device, and component of a system.

4. The first device of claim 1, wherein the establishing comprises first communications via a first channel between the first device and the plurality of second devices, and second communications via a second channel between the first device and a cloud computer.

5. The first device of claim 1, wherein the first device is configured to be portable.

6. The first device of claim 5, wherein the first device includes at least one of a smart phone, tablet computer, and portable computing device.

7. The first device of claim 5, wherein the processor is configured to run a configuration application to analyze the incoming signals, and generate the outgoing signal.

8. The first device of claim 1, wherein the outgoing signal is configured to include information to establish the adjacent second device of the plurality of second devices.

9. The first device of claim 1, wherein the outgoing signal is configured to include information to establish as the adjacent second device a nearest one of the plurality of second devices.

10. The first device of claim 1, wherein the outgoing signal is configured to include a radio frequency signal.

11. The first device of claim 1, wherein the analyzing the incoming signals comprises:
comparing signal strengths of the incoming signals received from the plurality of second devices; and
determining the distance of the first device to the plurality of second devices using the signal strength.

12. The first device of claim 1, wherein the incoming signal is configured to include a unique device identifier of a corresponding device of the at least one of the second devices.

13. The first device of claim 12, wherein the outgoing signal from the transmitter is configured to include an address.

14. The first device of claim 13, wherein the transmitter is configured to transmit a second outgoing signal to another device.

15. The first device of claim 14, wherein the second outgoing signal is configured to include the unique identifier and the address.

16. The first device of claim 1, wherein, subsequent to detecting a change in location of the first device relative to the plurality of second devices:
the receiver is configured to receive the incoming signals from the plurality of second devices;
the processor is configured to analyze the incoming signals received from the plurality of second devices to determine another second device adjacent to the first device;
the transmitter is configured to send the outgoing signal to the other second device, wherein the outgoing signal comprises information to configure the other second device.

17. A method for establishing a plurality of second devices comprising:
receiving at a first device incoming signals from the plurality of the second devices;
determining which of the plurality of second devices is adjacent to the first device by analyzing the incoming signals; and
transmitting an outgoing signal to the adjacent second device, wherein the outgoing signal includes data to configure the adjacent second device.

18. The method of claim 17, wherein the plurality of second devices includes at least one of a sensor and a detector.

19. The method of claim 17, wherein the plurality of second devices includes at least one of a beacon, controller, security device, audio component, video component, lighting component, network device, Internet-of-Things device, and component of a system.

20. The method of claim 17, wherein the configuring comprises first communications via a first channel between the first device and the plurality of second devices, and second communications via a second channel between the first device and a cloud computer.

21. The method of claim 17, wherein the first device is configured to be portable.

22. The method of claim 21, wherein the first device includes at least one of a smart phone, tablet computer, and portable computing device.

23. The method of claim 17, wherein the transmitting the outgoing signal comprises transmitting information to establish the adjacent second device.

24. The method of claim 17, wherein the transmitting the outgoing signal comprises transmitting information to establish as the adjacent second device a nearest one of the plurality of second devices.

25. The method of claim 17, wherein the outgoing signal is a radio signal.

26. The method of claim 17, wherein the analyzing the incoming signals comprises:
comparing signal strengths of the incoming signals received from the plurality of second devices; and
determining the distance of the first device to the plurality of second devices using the signal strength.

27. The method of claim 17, comprising configuring the incoming signal to include a unique device identifier of a corresponding device of the plurality of second devices.

28. The method of claim 27, comprising configuring the outgoing signal from the transmitter to include an address.

29. The method of claim 28, comprising configuring the transmitter to transmit a second signal to another device.

30. The method of claim 29, comprising configuring the second signal to include the unique identifier and the address.

31. The method of claim 17, comprising:
detecting a change in location of the first device relative to the plurality of second devices;
receiving at the first device incoming signals from the plurality of the second devices;
determining another second device adjacent to the first device by analyzing the incoming signals; and
transmitting an outgoing signal to the other second device, wherein the outgoing signal includes data to configure the other second device.

32. A device, comprising:
a transmitter configured to send an outgoing signal, wherein the outgoing signal comprises a unique identifier of the device;
a receiver configured to receive an incoming signal, wherein the incoming signal comprises an address; and
a processor configured to associate the address received with the unique identifier.

33. The device of claim 32, wherein the incoming signal is transmitted by a remote device in response to receipt of the outgoing signal.

34. The device of claim 32, wherein the device is configured as at least one of a sensor and a detector.

35. The device of claim 32, wherein the device is configured as at least one of a beacon, controller, security device, audio component, video component, lighting component, network device, Internet-of-Things device, and component of a system.

36. The device of claim 32, wherein the device is one of a plurality of devices deployed in an area.

37. The device of claim 36, wherein the device and the plurality of devices are deployed according to a pattern.

38. The device of claim 36, wherein the incoming signal is addressed to the device when the device is adjacent to a remote device transmitting the incoming signal.

39. The device of claim 36, wherein the incoming signal is addressed to the device when the device is nearer to a remote device transmitting the incoming signal than the plurality of devices.

40. A method for establishing a device, comprising:
transmitting an outgoing signal, wherein the outgoing signal comprises a unique identifier of the device;
receiving an incoming signal, wherein the incoming signal comprises an address; and
processing the incoming signal to determine the address; and
assigning the address to the device that transmitted the outgoing signal with the unique identifier.

41. The method of claim 40, comprising transmitting the incoming signal from a remote device in response to receipt of the outgoing signal.

42. The method of claim 40, comprising addressing the incoming signal to the device when the device is at least one of adjacent and nearest to a remote device transmitting the incoming signal.

43. The method of claim 40, wherein the determining the address comprises determining a logical address.

44. The method of claim 40, wherein the determining the address comprises determining a network address.

45. The method of claim 40, wherein the determining the address comprises determining a location string.

46. The method of claim 40, wherein the determining the address comprises determining a tag.
